(19) United States
(12) Patent Application Publication
(10) Pub. No.: US 2016/0128046 A1
(43) Pub. Date: May 5, 2016

(54) Bearer Configuration in Dual Connectivity Communication

(71) Applicant: NOKIA SIEMENS NETWORKS OY, Espoo (FI)

(72) Inventors: Benoist Pierre Sebire, Tokyo (JP); Woonhee Hwang, Espoo (FI)

(73) Assignee: Nokia Siemens Networks OY, Espoo (FI)

(21) Appl. No.: 14/889,511

(22) PCT Filed: May 9, 2013
(86) PCT No.: PCT/IB2013/053763

§ 371 Date: Nov. 6, 2015

(51) Int. Cl. H04W 72/04; H04W 76/02

(52) U.S. Cl. CPC H04W 72/0406; H04W 76/02

(57) ABSTRACT

A communication device with a bearer provided by a first node is provided with a configuration for a further component carrier by a second node. It is determined that the communication device has not been provided with at least one configuration parameter for configuration of the at least one further component carrier for the bearer. In response a corresponding at least one configuration parameter received from the first node Is used for configuring for the at least one further component carrier.

The application relates to bearers in a communication system and more particularly to configuration of a node for a bearer.

A communication system can be seen as a facility that enables communication sessions between two or more nodes such as fixed or mobile communication devices, access points such as base stations, servers, machine type servers, routers, and so on. A communication system and compatible communicating devices typically operate in accordance with a given standard or specification which sets out what the various entities associated with the system are permitted to do and how that should be achieved. For example, the standards, specifications and related protocols can define the manner how communication devices shall communicate with the access points, how various aspects of the communications shall be implemented and how the devices and functionalities thereof shall be configured.

A user can access the communication system by means of an appropriate communication device. A communication device of a user is often referred to as user equipment (UE) or terminal.

Signals can be carried on wired or wireless carriers. Examples of wireless systems include public land mobile networks (PLMN), satellite based communication systems and different wireless local networks, for example wireless local area networks (WLAN). Wireless systems can be divided into coverage areas referred to as cells, such systems being often referred to as cellular systems. A cell can be provided by a base station, there being various different types of base stations. Different types of cells can provide different features. For example, cells can have different shapes, sizes, functionalities and other characteristics. A cell is typically controlled by a control node.

A communication device is provided with an appropriate signal receiving and transmitting arrangement for enabling communications with other parties. In wireless systems a communication device provides a transceiver station that can communicate with another communication device such as e.g. a base station and/or another user equipment. A communication device such as a user equipment (UE) may access a carrier provided by a base station, and transmit and/or receive on the carrier. Before data can be transferred between user equipment and a base station, configuration of necessary entities is needed. Typically a cell specific configuration, a UE specific configuration and a bearer specific configuration for each active UE bearer should be communicated between eNB and UE.

An example of cellular communication systems is an architecture that is being standardized by the 3rd Generation Partnership Project (3GPP). A recent development in this field is often referred to as the long-term evolution (LTE) of the Universal Mobile Telecommunications System (UMTS) radio-access technology. In LTE base stations providing the cells are commonly referred to as enhanced NodeBs (eNB). An eNB can provide coverage for an entire cell or similar radio service area.

Cells can provide different service areas. For example, some cell may provide wide coverage areas while some other cells provide smaller coverage areas. The smaller radio coverage areas can be located wholly or partially within a larger radio coverage area. For example, in LTE a node providing a relatively wide coverage area is referred to as a macro eNode B. Examples of nodes providing smaller cells, or local radio service areas, include femto nodes such as Home eNBs (HeNB), pico nodes such as pico eNodeBs (pico-eNB) and remote radio heads.

A device may communicate with more than one cell. Communications with more than one cell may be provided e.g. to increase performance. A way of providing this is based on carrier aggregation (CA). In carrier aggregation a plurality of carriers are aggregated to increase bandwidth. Carrier aggregation comprises aggregating a plurality of component carriers into a carrier that can be referred to as an aggregated carrier.

LTE-Advanced is an example of a system capable of providing carrier aggregation. In LTE-A two or more component carriers (CCs) can be aggregated in order to support wider transmission bandwidths and/or for spectrum aggregation. Currently it is envisaged that the bandwidths can extend up to 100 MHz. Depending on its capabilities, it is possible to configure a user equipment (UE) to aggregate a different number of component carriers either from the same frequency band or different ones. A primary component carrier can be provided by a primary cell (PCell) whereas further carriers can be provided by at least one secondary cell (SCell). SCells form together with the PCell a set of serving cells. To enable reasonable battery consumption by the user equipment when aggregating carriers, an activation/deactivation mechanism of SCells is supported. When operated to provide CA a user equipment (UE) is configured with a primary cell (PCell). The PCell is used for taking care of security, Non-Access-Stratum (NAS) protocol mobility, and transmission of physical uplink control channel (PUCCH). All other configured CCs are called secondary cells (SCells).

Inter-site carrier aggregation has also been proposed. For example, it has been proposed that smaller cells could be used in conjunction with macro cells. In dual connectivity, a UE is connected to a macro cell and a small cell simultaneously. An aim of dual connectivity is to decrease mobility related signalling load towards the core network as well as to benefit from gains by the inter-site carrier aggregation. In some aspects dual connectivity is rather similar to CA with the macro cell serving as PCell and the small cells being SCells. However, in dual connectivity different eNBs provide the PCell and the sCell(s) as opposed to only one eNB according to e.g. 3GPP LTE Releases 10 and 11. A proposal is to use a Common Packet Data Convergence Protocol (PDCP) with separated Radio Link Control (RLC) and Medium Access Control (MAC) for user plane communications. In other words, the macro eNB can host the Packet Data Convergence Protocol (PDCP) layer while both the macro cell and the small cell host one RLC and one MAC each. The cells also host one physical layer each beneath these layers.

In the downlink, each bearer is first split in the macro in order to go through both the macro eNB and the small cell. Similarly in the uplink, the UE splits the bearer below PDCP and feeds RLC service data units (SDUs) to two stacks: one RLC/MAC for the macro cell and one RLC/MAC for the small cell. 5A problem relates to the radio resource control (RRC) configuration of the RLC and MAC entities for the small cell. A full configuration of all RLC/MAC entities of each branch (i.e. each serving cell) would significantly increase the overhead. Increase in overhead may not be desired, or even possible, in ail circumstances.

It is noted that the above discussed issues are not limited to any particular communication environment and station apparatus but may occur in any appropriate system.

Embodiments of the invention aim to address one or several of the above issues.

In accordance with an embodiment there is provided a method of obtaining configuration information by a communication device with a bearer provided by a first node, the method comprising determining, when at least one further component carrier for the bearer is to be established for the communication device via a second node, that the communication device has not been provided with at least one configuration parameter for configuration of the at least one further component carrier for the bearer, and using a corresponding at least one configuration parameter received from the first node for configuring for the at least one further component carrier.

In accordance with another aspect there is provided a method of providing configuration information for a communication device with a bearer provided by a first node, the method comprising signalling from the first node to the communication device configuration information regarding use of a second node for providing at least one further component carrier for the bearer when the communication device has not been provided with at least one configuration parameter for configuration of the at least one further component carrier for the bearer to cause configuration for the at least one further component carrier based on at least one corresponding configuration parameter received from the first node.

In accordance with an aspect there is provided a method of providing configuration information for communications with a communication device having a bearer provided by a first node, the method comprising signalling from the first node to a second node configuration information for enabling establishment of at least one further component carrier for the bearer via the second node, wherein the configuration information comprises at least one parameter for configuration of the at least one further component carrier for the bearer that corresponds to at least one configuration parameter used by the first node for the bearer.

In accordance with another aspect there is provided apparatus for a communication device, the apparatus comprising at least one processor, and at least one memory including computer program code, the at least one memory and the computer program code being configured to, with the at least one processor, cause the apparatus at least to determine, when at least one further component carrier for a bearer provided by a first node is to be established for the communication device via a second node, that the communication device has not been provided with at least one configuration parameter for configuration of the at least one further component carrier for the bearer, and use a corresponding at least one configuration parameter received from the first node for configuring for the at least one further component carrier.

In accordance with another aspect there is provided apparatus for a first network node, the apparatus comprising at least one processor, and at least one memory including computer program code, wherein the at least one memory and the computer program code are configured to, with the at least one processor, cause the apparatus at least to signal, when at least one further component carrier for a bearer provided by the first node is to be established for a communication device via a second node, to the communication device configuration information regarding use of a second node for providing at least one further component carrier for the bearer when the communication device has not been provided with at least one configuration parameter for configuration of the at least one further component carrier for the bearer to cause configuration for the at least one further component carrier based on at least one corresponding configuration parameter received from the first node.

In accordance with a more specific aspect the communication device can determine that at least one radio link control and/or medium access control configuration parameter has not been received by the communication device from the second node for configuring of at least one radio resource control entity.

The first node may be arranged to provide a macro cell and the second node to provide a cell that is smaller than the macro cell.

The first node may be arranged to signal to the communication device and/or the second node configuration parameters needed for configuration for the at least one further component carrier that are different from configuration parameters for the first node.

Configuration definitions for the first node and for the second node may be linked based on a data bearer identity of the bearer.

The missing at least one configuration parameter may comprise a parameter for use in configuring at least one of a radio link control entity, a radio link control logical channel, a logical channel identity, a uplink shared channel, discontinuous reception, a dedicated time alignment, and power headroom reporting.

The bearer may comprise a radio bearer or a radio link control bearer.

A computer program comprising program code means adapted to perform the herein described methods may also be provided. In accordance with further embodiments apparatus and/or computer program product that can be embodied on a computer readable medium for providing at least one of the above methods is provided.

A node such as a base station or a user equipment, for example a mobile station can be configured to operate in accordance with the various embodiments.

It should be appreciated that any feature of any aspect may be combined with any other feature of any other aspect.

Embodiments will now be described in further detail, by way of example only, with reference to the following examples and accompanying drawings, in which:

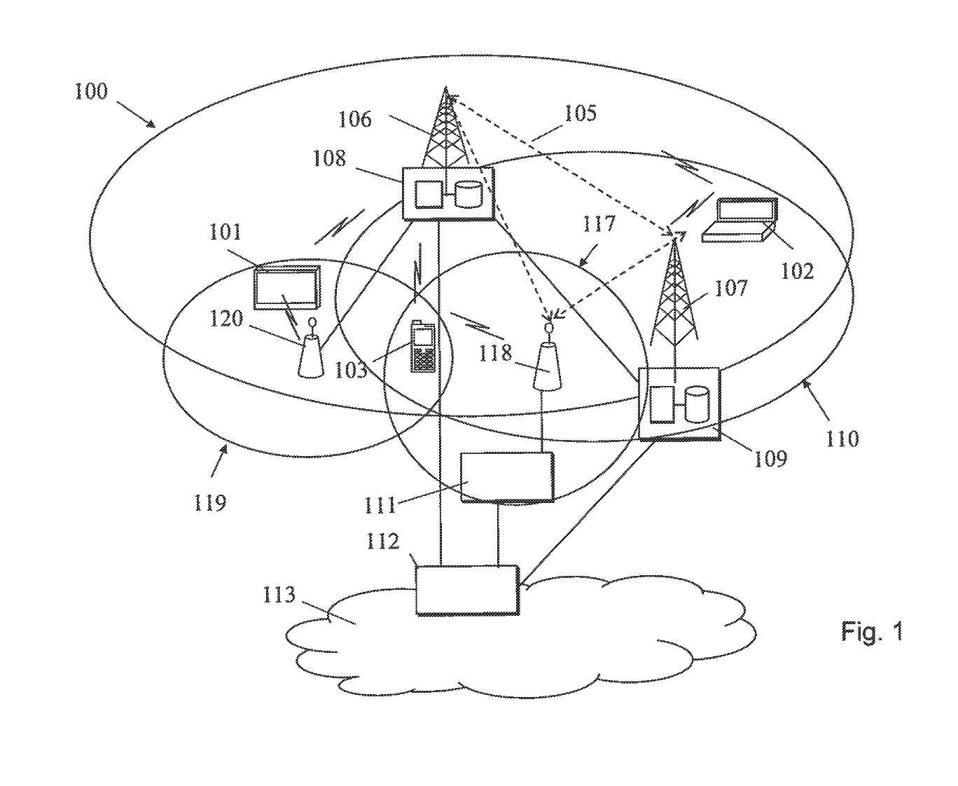

FIG. 1 shows a schematic diagram of a network according to some embodiments;

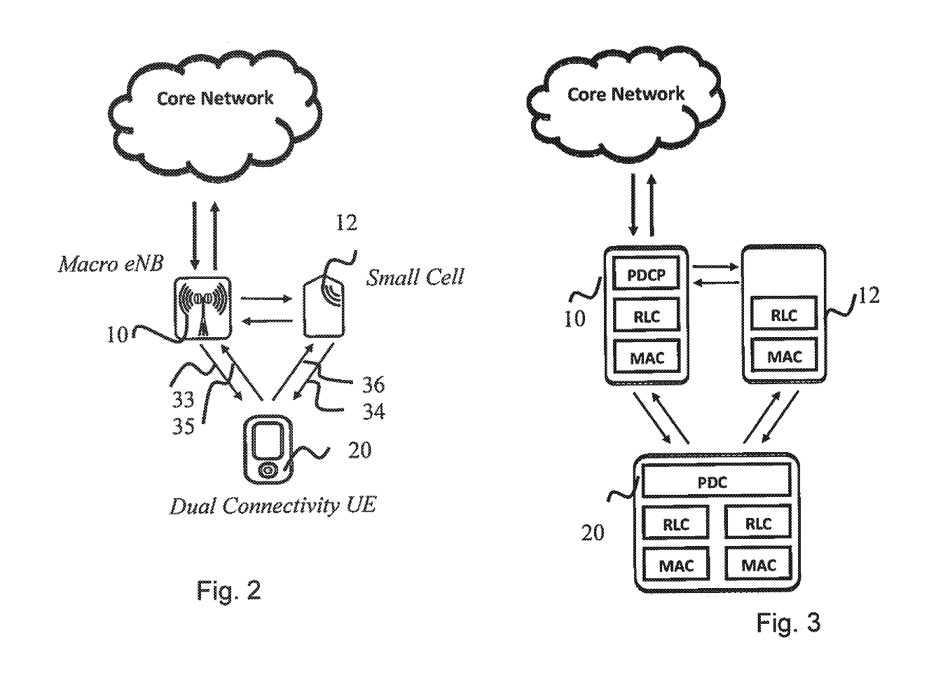

FIGS. 2 and 3 illustrate the principle of dual connectivity;

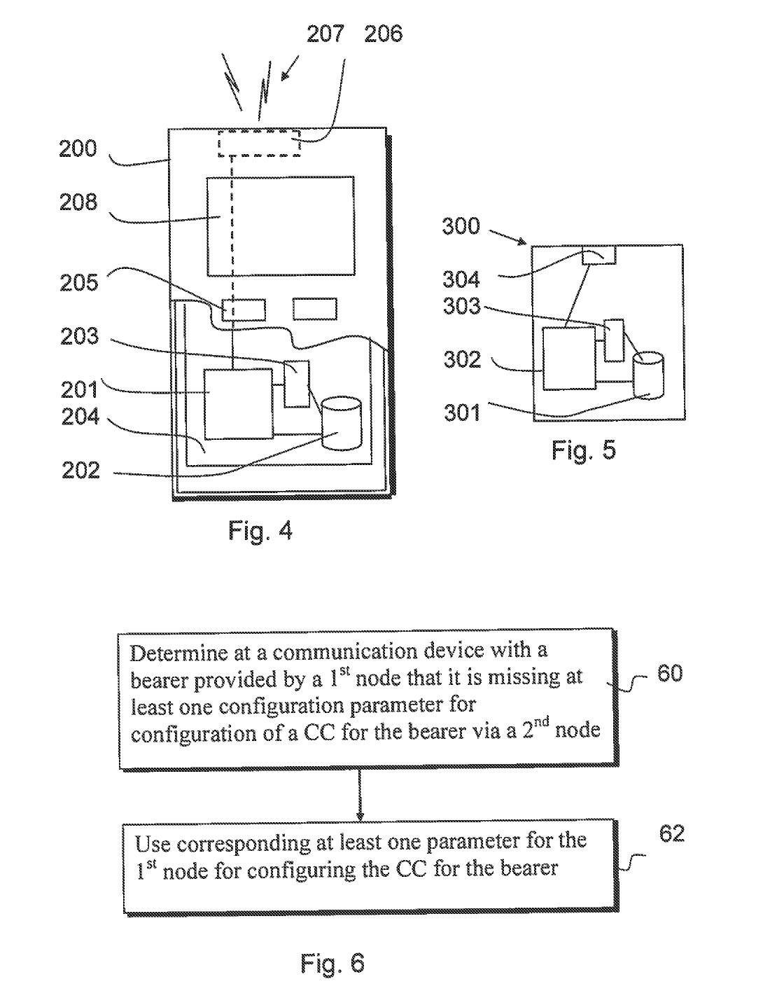

FIG. 4 shows a schematic diagram of a mobile communication device according to some embodiments;

FIG. 5 shows a schematic diagram of a control apparatus according to some embodiments; and

FIGS. 6 to 8 show flowcharts according to certain embodiments.

In the following certain exemplifying embodiments are explained with reference to a wireless or mobile communication system serving mobile communication devices. Before explaining in detail the exemplifying embodiments, certain general principles of a wireless communication system and nodes thereof and mobile communication devices are briefly explained with reference to FIGS. 1 to 5 to assist in understanding the context of the described examples.

A non-limiting example of the recent developments in communication system architectures is the long-term evolution (LTE) of the Universal Mobile Telecommunications System (UMTS) that is being standardized by the 3rd Generation Partnership Project (3GPP). The LTE employs a mobile architecture known as the Evolved Universal Terrestrial Radio Access Network (E-UTRAN). Base stations of such systems are known as evolved or enhanced Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (LAN) and/or WiMax (Worldwide Interoperability for Microwave Access). WLANs are sometimes referred to by WiFi™, a trademark that is owned by the Wi-Fi Alliance, a trade association promoting Wireless LAN technology and certifying products conforming to certain standards of interoperability.

Different types of communication devices 101, 102, 103 can be provided wireless access via base stations or similar wireless transmitter and/or receiver nodes providing radio service areas or cells. In FIG. 1 different neighbouring and/or overlapping radio service areas or cells 100, 110, 117 and 119 are shown being provided by base stations 105, 106, 118 and 119. It is noted that the cell borders are schematically shown for illustration purposes only in FIG. 1. It shall be understood that the sizes and shapes of the cells or other radio service areas may vary considerably from the omni-directional shapes of FIG. 1. A base station site can provide one or more cells or sectors, each sector providing a cell or a subarea of a cell. Each communication device and base station may have one or more radio channels open at the same time and may send signals to and/or receive signals from more than one source

Base stations are typically controlled by at least one appropriate controller apparatus so as to enable operation thereof and management of mobile communication devices in communication with the base stations. The control apparatus can be interconnected with other control entities. The control apparatus can typically be provided with memory capacity and at least one data processor. The control apparatus and functions may be distributed between a plurality of control units. In some embodiments, each base station can comprise a control apparatus. In alternative embodiments, two or more base stations may share a control apparatus. In some embodiments the control apparatus may be respectively provided in each base station.

Different types of possible cells include those known as macro cells, pico cells and femto cells. For example, transmission/reception points or base stations can comprise wide area network nodes such as a macro eNode B (eNB) which may, for example, provide coverage for an entire cell or similar radio service area. A base station can also be provided by small or local radio service area network node, for example Home eNBs (HeNB), pico eNodeBs (pico-eNB), or femto nodes. Some applications utilise radio remote heads (RRH) that are connected to for example an eNB. As cells can overlap a communication device in an area can listen and transmit to more than one base station. Smaller radio service areas can be located entirely or at least partially within a larger radio service area. A communication device may thus communicate with more than one cell.

In a particular example, FIG. 1 depicts a primary cell (PCell) 100. In this example the primary cell 100 can be provided by a wide area base station 106 provided by a macro-eNB. The macro-eNB 106 transmits and receives data over the entire coverage of the cell 100. A secondary cell (SCell) 110 in this example is a pico-cell. A secondary cell can also be provided by another suitable small area network node 118 such as Home eNBs (HeNB) (femto cell) or another pica eNodeBs (pico-eNB). A yet further cell 119 is shown to be provided by a remote radio head (RRH) 120 connected to the base station apparatus of cell 100.

Base station may communicate via each other via fixed line connection and/or air interface. The logical connection between the base station nodes can be provided for example by an X2 interface. In FIG. 1 this interface is shown by the dashed line denoted by 105.

FIG. 2 shows an example for dual connectivity where a UE 20 is connected to a macro cell 10 and a small cell 12 simultaneously. A Common Packet Data Convergence Protocol (PDCP) with separated Radio Link Control (RLC) and Medium Access Control (MAC) can be used for user plane communications. The macro eNB 10 can host the Packet Data Convergence Protocol (PDCP) layer while both the macro cell and the small cell host one RLC and one MAC each. The arrangement of the layers is shown in FIG. 3. The cells also host one physical layer each beneath these layers.

In the downlink, each bearer is first split in the macro to component carriers 33 and 34 in order to go through both the macro eNB 10 and the small cell 12. Similarly in the uplink, the UE splits the bearer below PDCP to component carriers 35 and 36 and feeds RLC service data units (SDUs) to two stacks such that one RLC/MAC is for the macro cell and one RLC/MAC for the small cell. The bearer to be split can comprise a radio bearer but this is not the only option. For example, an RLC bearer can be also be split between eNBs. Example for how to configure the radio bearer in both cells will be discussed later. However, similar principles can be applied to other bearer types.

In FIG. 1 stations 106 and 107 are shown as connected to a core network 113 via gateway 112. A further gateway function may be provided to connect the core network to another network. The smaller stations 118 and 120 can also be connected to the network 113, for example by a separate gateway function and/or via the macro level cells. In the example, station 118 is connected via a gateway 111 whilst station 120 connects via the controller apparatus 108.

A possible mobile communication device for transmitting to and receiving from a plurality of base stations will now be described in more detail with reference to FIG. 4 showing a schematic, partially sectioned view of a mobile communication device 200. Such a device is often referred to as user equipment (UE) or terminal. An appropriate mobile communication device may be provided by any device capable of sending radio signals to and/or receiving radio signals from multiple cells. Non-limiting examples include a mobile station (MS) such as a mobile phone or what is known as a ‘smart phone’, a portable computer provided with a wireless interface card, and USB stick or ‘dangle’ with radio, or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on.

The mobile device may receive and transmit signals over an air interface 207 with multiple base stations via an appropriate transceiver apparatus. In FIG. 4 transceiver apparatus is designated schematically by block 206. The transceiver apparatus 206 may be provided for example by means of a radio part and associated antenna arrangement. The radio part is arranged to communicate simultaneously with different stations. The radio part may also be arranged to communicate via different radio technologies. For example, the radio part can provide a plurality of different radios. The antenna arrangement may be arranged internally or externally to the mobile device.

A mobile communication device is also provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204.

The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 5 shows an example of a control apparatus for a communication system, for example to be coupled to and/or for controlling a transceiver base station of a cell. The control apparatus 300 can be arranged to provide control on communications in the service area of a cell to provide the functions described below. In some embodiments a base station can comprise a separate control apparatus. In other embodiments the control apparatus can be another network element. The control apparatus 300 can be configured to provide control functions in association with configurations for dual connectivity arrangements by means of the data processing facility in accordance with certain embodiments described below. For this purpose the control apparatus comprises at least one memory 301, at least one data processing unit 302, 303 and an input/output interface 304. Via the interface the control apparatus can be coupled to a receiver and a transmitter of the base station. The control apparatus can be configured to execute an appropriate software code to provide the control functions. It shall be appreciated that similar component can be provided in a control apparatus provided elsewhere in the system for controlling configurations of secondary nodes/cells.

A wireless communication device, such as a mobile or base station, can be provided with a Multiple Input/Multiple Output (MIMO) antenna system for enabling multi-flow communications. MIMO arrangements as such are known. MIMO systems use multiple antennas at the transmitter and receiver along with advanced digital signal processing to improve link quality and capacity. More data can be received and/or sent where there are more antennae elements. As mentioned, a communication device can receive from and/or transmit to more than one station at a time. Use of multiple flows is utilised e.g. in techniques known as carrier aggregation (CA) and/or coordinated multipoint (CoMP) transmissions. In carrier aggregation a plurality of component carriers are aggregated to increase bandwidth. An arrangement providing this is X2-based inter-site LIE carrier aggregation (CA)/coordinated multipoint (CoMP). X2 is a logical interface between base stations, for example enhanced NodeBs (eNB) as shown by the dashed lines 105 in FIG. 1.

FIG. 6 shows as flowchart for an embodiment for avoiding increasing signalling overhead for e.g. in radio resource control (RRC) configuration of RLC and MAC entities for a secondary cell. In the method, when at least one further component carrier for a bearer a communication device has with a first node is to be established via a second node, it is determined at 60 that the communication device has not been provided with at least one configuration parameter for configuration of the at least one further component carrier for the bearer. Corresponding at least one configuration parameter received from the first node is then used at 62 for configuring for the at least one further component carrier.

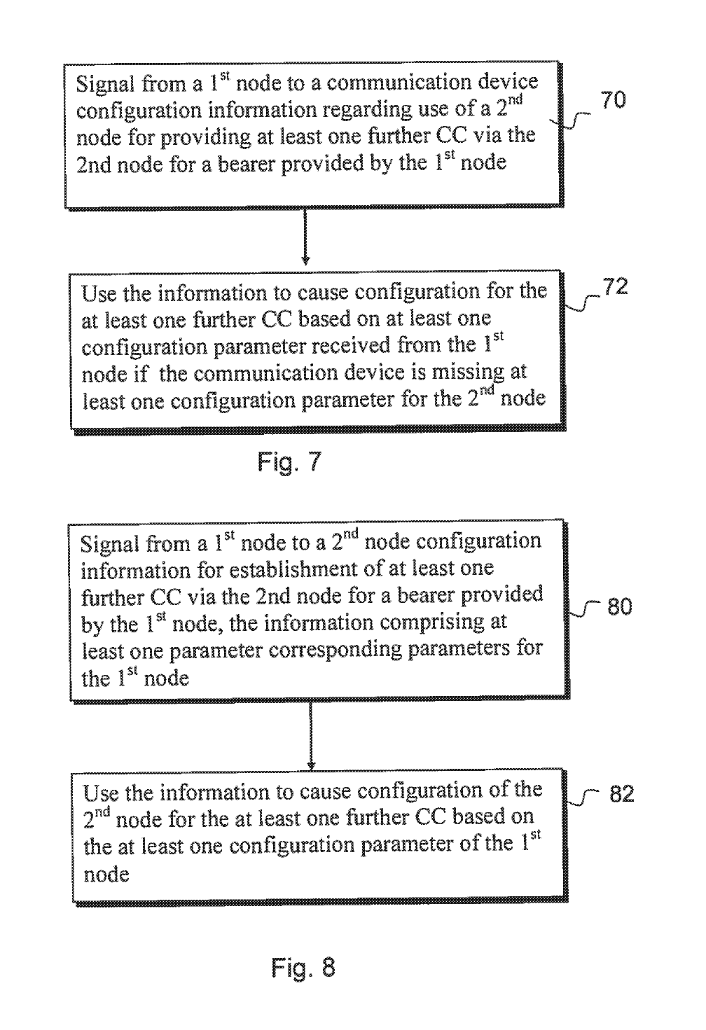

FIG. 7 shows a flowchart for operation in a network node for providing configuration information for a communication device with a bearer provided by a first node. In the method the first node signals at 70 to the communication device configuration information regarding use of a second node for providing at least one further component carrier for the bearer. When it is determined that the communication device has not been provided with at least one configuration parameter for configuration of the at least one further component carrier for the bearer, the information is used to cause configuration for the at least one further component carrier based on at least one corresponding configuration parameter received from the first node.

FIG. 8 shows a flowchart for operation for providing a second node with configuration information for communications with a communication device having a bearer provided via a first node. In the method the first node signals at 80 to the second node configuration information for enabling establishment of at least one further component carrier for the bearer via the second node. The configuration information comprises at least one parameter for configuration of the at least one further component carrier for the bearer that corresponds to at least one configuration parameter of the first node.

The second node, for example a SCell ENB, can thus also obtain configuration information for a bearer provided by a first node from the first node, e.g. a PCell eNB. That is, the second node can receive configuration information from the first node for configuring for least one further component carrier for the bearer to be established for the communication device via the second node, the configuration information comprising a corresponding at least one configuration parameter the first node has used for configuring for the bearer and configure for the at least one further component carrier at least partially based on the received at least one configuration parameter.

The communication device can, having determined that it is missing at least one configuration parameter for it to be able to configure for the at least one further component carrier via the second node use at least one corresponding parameter of the first node for the configuring. In accordance with a possibility one or more network elements controlling the configurations can provide the communication device with a full configuration via a first node and only a partial configuration via the second node. The communication device can the apply parameters received from the first node to the second node should any of the required parameters be missing.

The missing parameter can comprise at least one radio link control and/or medium access control configuration parameter that has not been received by the communication device for configuration of at least one radio resource control entity.

The following discusses more detailed examples based on the LTE based configuration processes. According to current versions of LTE Release 12 there are different eNBs that have different RLC/MAC entities. The difference may be e.g. such that RLC/MAC entities are physically different and reside in different nodes. The RLC and MAC layers need thus to be configured separately in each eNB for a bearer.

The configuration in RRC for RLC/MAC entities per bearer is currently based on DRB-ToAddModList, an information element (IE) that can be presented as:

DRB-ToAddMod ::= SEQUENCE {

| | | |
|---|---|---|
| eps-BearerIdentity | INTEGER(0..15) | OPTIONAL,- Cond |
| | | DRB-Setup |
| drb-Identity | DRB-Identity, | |
| pdcp-Config | PDCP-Config | OPTIONAL,-- Cond PDCP |
| rlc-Config | RLC-Config | OPTIONAL,-- Cond Setup |

| | |
|---|---|
| logicalChannelIdentity INTEGER (3..10) | OPTIONAL,-- Cond |
| DRB-Setup | |

```
  logicalChannelConfig LogicalChannelConfig OPTIONAL,-- Cond
  Setup
  ...
}
```

The current rule is that for each drb-Identity parameter value included in the drb-ToAddModList that is part of the current UE configuration of data radio bearer (DRB) reconfiguration:
if the pdcp-Config is included: reconfigure the PDCP entity in accordance with the received pdcp-Config;
if the rlc-Config is included: reconfigure the RLC entity or entities in accordance with the received rlc-Config;
if the logicalChannelConfig is included: reconfigure the DTCH logical channel in accordance with the received logicalChannelConfig.
Removal and addition of the same drb-Identity in single radioResourceConfiguration message is not supported.

In accordance with a possibility the arrangement is changed such that the configuration of a PCell is referred to when one or more SCells need to be configured for handling an existing bearer. The rule can be that if a configuration for the bearer is missing for the SCell, the corresponding configuration for that bearer in the PCell is taken into use for the handling of that bearer in the SCell. The user equipment can determine that it has not received all necessary configuration parameters, and in response thereto uses as a default the PCell parameters for bearer specific configuration.

In accordance with a more detailed example, when a SCell needs to be configured to support a data radio bearer (DRB) that is also supported in a dual connectivity arrangement by a PCell, the following rules apply:
if the SCell configuration for that DRB does not include a value for rlc-Config parameter then the rlc-Config value of the same DRB in the PCell applies to the SCell;
if the SCell configuration for that DRB does not include a value for logicalChannelConfig parameter, then the logicalChannelConfig value of the same DRB in the PCell applies to the SCell;
if the SCell configuration for that DRB does not include value for logicalChannelIdentity parameter, then the logicalChannelIdentity of the same DRB in the PCell applies to the SCell.

Similar rules can be applied to MAC configuration:
if the SCell configuration does not include a value for ul-SCH-Config parameter, then the ul-SCH-Config value used in the PCell applies to the SCell;
if the SCell configuration does not include value for drx-Config parameter, then the drx-Config in the PCell applies to the SCell;
if the SCell configuration does not include value for timeAlignmentTimerDedicated parameter, then the timeAlignmentTimerDedicated value of the PCell applies to the SCell;
if the SCell configuration does not include value for phr-Config parameter, then the phr-Config value used in the PCell applies to the SCell.

In accordance with an example, a PCell eNB can send configuration information to a UE which can then use this information to complement any configuration information missing for configuration for a SCell provided by a different eNB. As it can be that only PCell eNB has established RRC it follows that only the PCell eNB can send a RRC configuration message to the UE. PCell eNB can send its own parameters to the UE and also additional parameters regarding configuration for SCell. The SCell eNB may provide resource information beforehand to the PCell eNB or during a bearer setup to enable this. Exchange of information such as configuration parameters may occur between the eNBs e.g. via the X2 interface. In accordance with an embodiment only those configuration parameters are signalled by the first node, e.g. PCell eNB to the communication device for configuration of the second node, e.g. SCell eNB that are different from the configuration parameters of first node. Signalling only an individual parameter or only some of the configuration parameters of e.g. the above discussed information element (IE) can be provided to decrease the granularity of the parameters. That is, only those parameters are signalled from the PCell to the UE which are to be different for the SCell(s) from the PCell.

In accordance with a possibility a DRB-ToAddModList or the like is added in a message such as RadioResourceconfigDedicatedSCell-r10. This addition is shown in bold below:

RadioResourceConfigDedicatedSCell-r10 ::= SEQUENCE {

| -- UE specific configuration extensions applicable for an SCell | |
|---|---|
| physicalConfigDedicatedSCell-r10 PhysicalConfigDedicatedSCell-r10 | |
| OPTIONAL, -- Need ON | |
| ..., | |
| [[mac-MainConfigSCell-r11 | MAC-MainConfigSCell-r11 |
| OPTIONAL -- Cond SCellAdd | |
| ]], | |
| [[drb-ToAddModListSCell-r12 | DRB-ToAddModListSCell-r12 |
| OPTIONAL | |
| ]] | |

}
DRB-ToAddModListSCell ::= SEQUENCE (SIZE (1..max.DRB)) OF DRB-
ToAddModSCell
DRB-ToAddModSCell ::= SEQUENCE {

| | | |
|---|---|---|
| drb-Identity | DRB-Identity, | |
| rlc-Config | RLC-Config | OPTIONAL, |
| logicalChannelIdentity | INTEGER (3..10) | OPTIONAL, |
| logicalChannelConfig | LogicalChannelConfig | OPTIONAL, |
| ... | | |

}

Configuration definitions for the first node and for the second node can be linked based on a data radio bearer identity of the radio bearer. In the above the drb-Identity parameter can provide a linkage between the ORB definition of a PCell that corresponds to the DRB in a SCell. If the network does not include any of the parameters inside DRB-ToAddModSCell information element, the same parameter as for the same ORB in PCell configuration will be assumed by the relevant UE. By signalling in this way, rest of the signalling for carrier aggregation can be reused.

A possibility is to provide MAC-MainConfig information is to add the necessary parameters in MAC-MainConfigSCell-r11 message. An example of such addition is shown in bold below,

MAC-MainConfigSCell-r11 ::=SEQUENCE {

| | |
|---|---|
| secTAG-Id-r11 | SecTAG-Id-r11 OPTIONAL, -- Need OP |
| ..., | |
| u1-SCH-Config | SEQUENCE { |
| maxHARQ-Tx | ENUMERATED { |
| | n1, n2, n3, n4, n5, n6, n7, n8, |
| | n10, n12, n16, n20, n24, n28, |
| | spare2, spare1} OPTIONAL, -- Need ON |
| periodicBSR-Timer | ENUMERATED { |
| | sf5,sf10,sf16,sf20,sf32,sf40,sf64,sf80, |
| | sf128,sf160,sf320,sf640,sf1280,sf2560, |
| | infinity, spare1} OPTIONAL, -- Need ON |
| retxBSR-Timer | ENUMERATED { |
| | sf320, sf640, sf1280, sf2560, sf5120, |
| | sf10240, spare2, spare1}, |
| ttiBundling | BOOLEAN |

| | |
|---|---|
| } | OPTIONAL, |

| | | |
|---|---|---|
| drx-Config | DRX-Config | OPTIONAL, |
| timeAlignmentTimerDedicated | TimeAlignmentTimer | OPTIONAL, |

| | |
|---|---|
| phr-Config | CHOICE { |
| release | NULL, |
| setup | SEQUENCE { |
| periodicPHR-Timer | ENUMERATED {sf10,sf20,sf50,sf100, |
| | sf200, sf500, sf1000, infinity}, |
| prohibitPHR-Timer | ENUMERATED{sf0,sf10,sf20,sf50,sf100, |
| | sf200, sf500, sf1000}, |
| d1-PathlossChange | ENUMERATED {dB1, dB3, dB6, infinity} |
| } | |

| | |
|---|---|
| } | OPTIONAL} |

It is noted that whilst embodiments have been described in relation to LTE and certain releases thereof, similar principles can be applied to any other communication system or indeed to further developments with LTE. For example, instead of the specific configuration parameters mentioned in the above examples the missing at least one configuration parameter can comprises any appropriate parameter for use in configuring at least one of a radio link control entity, a radio link control logical channel, a logical channel identity, a uplink shared channel, discontinuous reception, a dedicated time alignment, and power headroom reporting in a node proving a secondary cell.

Also, instead of carriers provided by different base station nodes at least one of the carriers may be provided by a communication device such as a mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein.

The required data processing apparatus and functions of a base station apparatus, a communication device and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1. A method of obtaining configuration information in a communication device with a bearer provided by a first node, the method comprising:
determining, when at least one further component carrier for the bearer is to be established for the communication device via a second node, that the communication device has not been provided with at least one configuration parameter for configuration of the at least one further component carrier for the bearer, and
using a corresponding at least one configuration parameter received from the first node for configuring for the at least one further component carrier.

2. A method according to claim 1, wherein the determining comprises determining that at least one radio link control and/or medium access control configuration parameter has not been received by the communication device from the second node for configuring of at least one radio resource control entity.

3. A method of providing configuration for a communication device with a bearer provided by a first node, the method comprising signalling from the first node to the communication device configuration information regarding use of a second node for providing at least one further component carrier for the bearer when the communication device has not been provided with at least one configuration parameter for configuration of the at least one further component carrier for the bearer to cause configuration for the at least one further component carrier based on at least one corresponding configuration parameter received from the first node.

4. A method of providing configuration information for communications with a communication device having a bearer provided by a first node, the method comprising signalling from the first node to a second node configuration information for enabling establishment of at least one further component carrier for the bearer via the second node, wherein the configuration information comprises at least one parameter for configuration of the at least one further component carrier for the bearer that corresponds to at least one configuration parameter used by the first node for the bearer.

5. A method of obtaining configuration information for a bearer provided by a first node for a communication device, the method comprising:
receiving at a second node configuration information from the first node for configuring for least one further component carrier for the bearer to be established for the communication device via the second node, wherein the configuration information comprises a corresponding at least one configuration parameter the first node has used for configuring for the bearer, and
configuring the second node for the at least one further component carrier at least partially based on the received at least one configuration parameter.

6. A method according to any preceding claim, wherein the first node provides a macro cell and the second node provides a cell that is smaller than the macro cell.

7. A method according to any preceding claim, comprising signalling from the first node to the communication device and/or the second node configuration parameters needed for configuration for the at least one further component carrier that are different from configuration parameters for the first node.

8. A method according to any preceding claim, comprising linking configuration definitions for the first node and for the second node based on a data bearer identity of the bearer.

9. A method according to any preceding claim, wherein the missing at least one configuration parameter comprises a parameter for use in configuring at least one of a radio link control entity, a radio link control logical channel, a logical channel identity, a uplink shared channel, discontinuous reception, a dedicated time alignment, and power headroom reporting.

10. A method according to any preceding claim, wherein the first cell provides a primary cell and the second cell provides a secondary cell in accordance with the definitions by the third Generation Partnership Project (3GPP), the first node and the second node each comprise an enhanced NodeB, and the missing at least one configuration parameter comprises at least one of rlc-Config, logicalChannelConfig, logicalChannelIdentity, ul-SCH-Config, drx-Config, timeAlignmentTimerDedicated, and phr-Config.

11. An apparatus for a communication device, the apparatus comprising at least one processor, and at least one memory including computer program code, the at least one memory and the computer program code being configured to, with the at least one processor, cause the apparatus at least to
determine, when at least one further component carrier for a bearer provided by a first node is to be established for the communication device via a second node, that the communication device has not been provided with at least one configuration parameter for configuration of the at least one further component carrier for the bearer, and
use a corresponding at least one configuration parameter received from the first node for configuring for the at least one further component carrier.

12. An apparatus according to claim 11, configured to determine that at least one radio link control and/or medium access control configuration parameter has not been received by the communication device and/or by the second node for configuring at least one radio resource control entity for the at least one further component carrier.

13. An apparatus for a first node, the apparatus comprising at least one processor, and at least one memory including computer program code, wherein the at least one memory and the computer program code are configured to, with the at least one processor, cause the apparatus at least to signal, when at least one further component carrier for a bearer provided by the first node is to be established for a communication device via a second node, to the communication device configuration information regarding use of a second node for providing at least one further component carrier for the bearer when the communication device has not been provided with at least one configuration parameter for configuration of the at least one further component carrier for the bearer to cause configuration for the at least one further component carrier based on at least one corresponding configuration parameter received from the first node.

14. An apparatus according to claim 13, configured to signal to the second node configuration information for enabling the establishment of the at least one further component carrier via the second node, said configuration information comprising at least one parameter for configuration of the at least one further component carrier for the bearer that corresponds to at least one configuration parameter used by the first node for the bearer.

15. An apparatus for a second node for, the method comprising, the apparatus comprising at least one processor, and at least one memory including computer program code, wherein the at least one memory and the computer program code are configured to, with the at least one processor, cause the apparatus at least to
receive from a first node providing a bearer for a communication device configuration information for configuring for least one further component carrier for the bearer to be established for the communication device via the second node, wherein the configuration information comprises a corresponding at least one configuration parameter the first node has used for configuring for the bearer, and
configure the second node for the at least one further component carrier at least partially based on the received at least one configuration parameter.

16. An apparatus according to any of claims 11 to 15, wherein the first node comprises a node for a macro cell and the second node comprises a node for a cell that is smaller than the macro cell.

17. An apparatus according to any of claims 11 to 16, configured for operation where the first node signals to the communication device and/or the second node configuration parameters needed for configuring for the at least one further component carrier that are different from configuration parameters for the first node.

18. An apparatus according to any of claims 11 to 17, configured to link configuration definitions for the first node and for the second node based on a data bearer identity of the bearer.

19. An apparatus according to any of claims 11 to 18, wherein the missing at least one configuration parameter comprises a parameter for use in configuring at least one of a radio link control entity, a radio link control logical channel, a logical channel identity, a uplink shared channel, discontinuous reception, a dedicated time alignment, and power headroom reporting.

20. An apparatus according to any of claims 11 to 19, wherein the first cell comprises a primary cell and the second cell comprises a secondary cell in accordance with the definitions by the third Generation Partnership Project (3GPP), the first node and the second node each comprise an enhanced NodeB, and the missing at least one configuration parameter comprises at least one of rlc-Config, logicalChannelConfig, logicalChannelIdentity, ul-SCH-Config, drx-Config, timeAlignmentTimerDedicated, and phr-Config.

21. An apparatus according to any of claims 11 to 20, wherein the bearer comprises a radio bearer or a radio link control bearer.

22. A user equipment comprising the apparatus of claim 11 or any claim dependent on claim 11.

23. A node for a radio access network comprising the apparatus of claim 13 or 15 or any claim dependent on claim 13 or 15.

24. A computer program comprising program code means adapted to perform the steps of any of claims 1 to 10 when the program is run on a data processing apparatus.
